(19) United States
(12) Patent Application Publication
(10) Pub. No.: US 2009/0026853 A1
(43) Pub. Date: Jan. 29, 2009

(54) TRANSVERSE FLUX MACHINE

(76) Inventors: Ingolf GROENING, Lohr am Main (DE); Christian KAEHLER, Wuerselen (DE); Stefan STEINBOCK, Urspringen (DE)

Correspondence Address: Striker, Striker & Stenby, 103 East Neck Road, Huntington, NY, 11743, US

(21) Appl. No.: 12/173,505

(22) Filed: Jul. 15, 2008

(30) Foreign Application Priority Data
Jul. 24, 2007 (DE) 10 2007 034 929.9

(51) Int. Cl. H02K 5/00

(52) U.S. Cl. 310/42

(57) ABSTRACT

The invention shows a transverse flux machine, including a transverse flux machine housing (200) with a stator (100) located in it and with a rotor rotating about an axis of rotation (A), wherein the stator (100) includes a coil assembly; wherein the coil assembly has at least one phase winding for connection to an electrical phase; and wherein the stator (100) has at least one first locating means (110) for locating and aligning the stator (100) inside the transverse flux machine housing (200).

### CROSS-REFERENCE TO A RELATED APPLICATION

The invention described and claimed hereinbelow is also described in German Patent Application DE 10 2007 034 929.9 filed on Jul. 24, 2007. This German Patent Application, subject matter of which is incorporated herein by reference, provides the basis for a claim of priority of invention under 35 U.S.C. 119(a)-(d).

### BACKGROUND OF THE INVENTION

The invention relates to a transverse flux machine, including a transverse flux machine housing with a stator located in it and with a rotor rotating about an axis of rotation, wherein the stator includes a coil assembly.

A transverse flux machine (TFM) typically comprises one stationary primary part (stator) and one movable or rotating secondary part (rotor), of which the one has a permanent magnet, while the other is conversely provided with a coil assembly extending in the direction of motion or rotation. A transverse flux machine is typically equipped with a one-, two- or three-phase coil assembly, that is, one that has one, two or three phase windings, and the individual phase windings of the coil assembly are typically insulated magnetically and electrically from the other phase windings.

A three-phase rotary transverse flux machine of a known design has a stator with three electrically and magnetically insulated phase windings, extending in the circumferential direction, which are each located in iron yokes for guiding the magnetic flux. The yokes are typically U- or C-shaped and can comprise either solid material or individual joined-together metal sheets. The yokes open in the radial direction, that is, perpendicular to the axis of rotation of the machine. The legs of the yokes point in the direction of the rotor provided with permanent magnets, and the magnetically active area is determined by the face end of the yoke legs. A phase module has yokes that belong together with a winding (phase module winding) extending inside it. A phase winding can also extend over a plurality of phase modules. Inserting the stator or phase modules into the machine housing is very complicated, since on the one hand care must be taken to ensure not only the correct location of the individual phase windings in the housing and relative to one another—which in the case of a three-phase machine are for instance spaced apart by 120° from one another—but also the cabling and the intactness of the cabling. As a result, incorrect assembly often occurs. The free structural space in conventional housings is severely limited, which makes the aforementioned difficulties even worse.

### SUMMARY OF THE INVENTION

It is therefore the object to disclose a transverse flux machine in which the aforementioned disadvantages are lessened and which assures easier assembly.

This object is attained by a transverse flux machine having the characteristics of claim 1. Advantageous features are the subject of the dependent claims and of the ensuing description.

A transverse flux machine of the invention has a transverse flux machine housing with a stator located in it and with a rotor rotating about an axis of rotation, the stator includes a coil assembly; the coil assembly has at least one phase winding for connection to an electrical phase. The stator has at least one first locating means for locating and aligning the stator inside the transverse flux machine housing.

A phase winding is characterized in that it is intended for connection to an electrical phase such as U, V or W in the case of rotary current. It can also comprise a plurality of individual windings or phase module windings, and the stator can likewise have a plurality of phase modules. The rotor can also include a coil assembly but preferably has a permanent magnet assembly.

Embodying a transverse flux machine according to the invention simplifies the production and construction of such a transverse flux machine substantially, and the risk of incorrect assembly is minimized. Locating means are provided, with which the correct positioning and the secure hold of the stator and phase modules inside the housing are assured.

Expediently, the at least one first locating means is capable of being brought into operative connection with at least one second locating means of the transverse flux machine housing, for locating and aligning the stator inside the transverse flux machine housing. With this characteristic it is possible in a simple way to furnish a defined location and alignment of the stator inside the housing, which further reduces the risk of misplacement.

It is especially preferable if the at least one first locating means is embodied as a recess, and the at least one second locating means is embodied as a protuberance, or vice versa. A recess and a protuberance cooperating with it make for an especially simple and thus especially expedient embodiment of the first and second locating means. A recess and a protuberance cooperating with it are especially robust, since in particular they include no moving parts or other fastening means that can for instance open or come loose. It is an attractive option for the one recess, or the plurality of recesses, and the one protuberance, or the plurality of protuberances, to extend axially in the installation direction, which typically corresponds to the axis of rotation. It is thus possible to locate and align the stator and the phase modules correctly by simply inserting them into the transverse flux machine housing. The protuberances and recesses may—like all the other corresponding locating means—in the case of an external stator assembly be provided in particular on the inside of the transverse flux machine housing and the outside of the stator or phase modules. In the case of an internal stator assembly, it is an attractive option for instance to provide the recess or recesses on an inside of an annular stator and to provide the protuberance or protuberances on an outside of a middle component of the housing, such as a peg, and for the stator and phase modules to be thrust onto that component.

In an especially preferred embodiment, a number of M×N recesses is provided, where N is the number of electrical phases, typically three, and M is a natural number. The recesses are expediently distributed uniformly in the circumferential direction. The correct positioning of the individual phase windings and phase modules can then be attained simply, and the alignment is of a function of the number of electrical phases. In a three-phase machine, for instance, the phase windings should be rotated by 120° each from one another, to minimize a torque waviness or ripple. In the above-mentioned connection, a three-phase machine therefore has three or six or nine recesses, and so forth; that is, the recesses are spaced apart by 120°, or 60°, or 30°, etc. It is thus possible by simply rotating the components provided with the recesses and the cooperating protuberances to furnish the angularly correct location.

Expediently, fewer protuberances than recesses are provided. It is thus possible, by means of the recesses not affected by a protuberance, to furnish conduits in which supply lines or connection lines, for instance, for the phases or for sensors can be carried for instance to a cable connector or box (terminal block). It is equally possible to extend cooling lines, for instance, through these conduits, making it possible to attain good cooling of the stator. Sensors, for instance, can also be located in the conduits. It is understood that it is equally possible for an equal number of recesses and protuberances to be provided, but in that case the aforementioned advantages are not attained.

In a further especially preferred embodiment of the invention, the stator is embodied as an external stator with recesses on the outside, and the transverse flux machine housing has protuberances on the inside. This embodiment makes the especially simple, reliable insertion of the stator modules into the transverse flux machine housing possible. The provision of protuberances, particularly on the inside of the housing, is unproblematic because as a rule, such housings are extruded profiles or cast material, so that the protuberances need merely be present in the mold (extrusion or casting mold).

It is understood that the characteristics mentioned above and those yet to be explained below can be used not only in the particular combination indicated but in other combinations or alone, without departing from the scope of the present invention.

The invention is shown schematically in the drawings in terms of an exemplary embodiment and described in detail below in conjunction with the drawings.

### BRIEF DESCRIPTION OF THE DRAWINGS

FIG. 1 schematically shows a preferred embodiment of a stator component of a transverse flux machine; and

FIG. 2 schematically shows a cross section through a preferred embodiment of a transverse flux machine housing.

### DESCRIPTION OF THE PREFERRED EMBODIMENTS

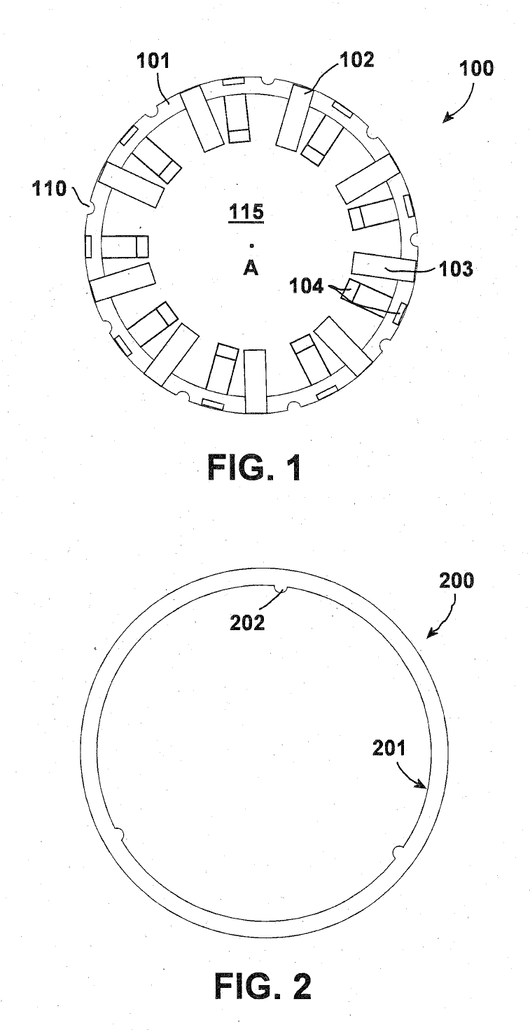

In FIG. 1, part of a phase module 100 of a stator is shown schematically in a top view. The phase module includes a phase module back 101 and pole elements 102 attached to it. The pole elements 102 are C-shaped, with a pole element back 103 and two pole element legs 104 and are secured to the phase module back 101 in alternation in the circumferential direction. In the top view shown, the pole element backs 103 of the pole elements 102 are therefore located in alternation above and below the phase module back 101. A phase module winding (not shown), which depending on the number of phase modules and on the phase windings may be a component of a phase winding or may be a phase winding itself, extends inside the C-shaped opening between the pole element legs 104 of the pole elements 102. An open space 115 for receiving the rotor is provided inside the phase module 100.

All the phase modules and phase module windings that are provided for connection to the same electrical phase form what is known as the phase winding. If the transverse flux machine is intended for connection to a three-phase rotary current, then it has three phase windings, which can each include a plurality of phase module windings. The phase windings together form the coil assembly of the transverse flux machine.

The phase module 100 is part of a three-phase transverse flux machine, and in the preferred exemplary embodiment shown, it has nine recesses 110 in the phase module back 101, which extend parallel to the axis of rotation A of the transverse flux machine and are preferably embodied in those regions of the phase module back 101 that do not have a pole element 102. In a three-phase transverse flux machine, the phase module back of each phase module 100 advantageously has at least three recesses 110 or an integral multiple thereof. The recesses 110 are advantageously distributed uniformly in the circumferential direction on the phase module back 101. It will be noted that the number of recesses is not in any particular relationship to the number of pole elements, and the number of pole elements shown is to be understood as merely an example.

In FIG. 2, a preferred embodiment of a transverse flux machine housing 200 is shown schematically in cross section and identified overall by reference numeral 200. The transverse flux machine housing 200 is suitable for receiving not only a stator with phase modules 100 as in FIG. 1 but also an internal rotor (not shown), which in particular has a permanent magnet assembly. The transverse flux machine housing 200, on its inside 201, has protuberances 202, which are intended for interaction with the recesses 110 of FIG. 1. The transverse flux machine housing 200 has three equally spaced-apart protuberances 202 on its inside, which are capable of cooperating with every third recess 1 10, located in the circumferential direction, of the phase module 100.

In the preferred embodiment shown, the transverse flux machine housing 200 has fewer protuberances 202 than the phase module 100 has recesses 110. In this way, by means of the recesses 110 that are not filled, conduits can advantageously be furnished that are suitable in particular for receiving lead lines, cooling lines, sensors, and so forth.

By means of the locating means shown, it is possible in a simple way to introduce for instance three phase modules, each representing one phase winding, with their associated phase module windings into the transverse flux machine housing, rotating by 120° each from one another. The recesses 110 and protuberances 202 cooperate in order to assure the location and guidance of the phase modules and of the stator. The recesses 110 not subjected to a protuberance 210 can advantageously be used in particular as line or cooling conduits, thermal sensors, and so forth.

It is understood that in the drawings shown, only one particularly preferred embodiment of the invention is shown. In addition to it, any other embodiment, in particular with a different kind or number of locating means, is conceivable without departing from the scope of this invention.

1. A transverse flux machine, including a transverse flux machine housing (200) with a stator (100) located in it and with a rotor rotating about an axis of rotation (A), wherein the stator (100) includes a coil assembly; wherein the coil assembly has at least one phase winding for connection to an electrical phase; and wherein the stator (100) has at least one first locating means (110) for locating and aligning the stator (100) inside the transverse flux machine housing (200).

2. The transverse flux machine as defined by claim 1, wherein the at least one first locating means (110) is capable of being brought into operative connection with at least one second locating means (202) of the transverse flux machine housing (200), for locating the stator (100) inside the transverse flux machine housing (200).

3. The transverse flux machine as defined by claim 2, wherein the at least one first locating means is embodied as a recess (110), and the at least one second locating means is embodied as a protuberance (202), or vice versa.

4. The transverse flux machine as defined by claim 3, wherein a number of M×N recesses (110) is provided, where N is the number of electrical phases intended for connection, and M is a natural number.

5. The transverse flux machine as defined by claim 3, wherein fewer protuberances (202) than recesses (110) are provided.

6. The transverse flux machine as defined by claim 4, wherein the stator is embodied as an external stator (100) with recesses (110) on the outside, and the transverse flux machine housing (200) has protuberances (202) on the inside.
